(19) United States
(12) Patent Application Publication
(10) Pub. No.: US 2017/0244303 A1
(43) Pub. Date: Aug. 24, 2017

(54) APPARATUS FOR GENERATING ELECTRIC CURRENT

(71) Applicant: VINCENZO DE FAZIO, LAMEZIA TERME (IT)

(72) Inventor: VINCENZO DE FAZIO, LAMEZIA TERME (IT)

(21) Appl. No.: 15/505,947

(22) PCT Filed: Aug. 19, 2015
(86) PCT No.: PCT/IT2015/000204

§ 371 Date: Feb. 23, 2017

(30) Foreign Application Priority Data
Aug. 26, 2014 (IT) CS2014A000024

(51) Int. Cl. H02K 7/18; A45C 5/14; H02K 7/116

(52) U.S. Cl. CPC H02K 7/1846; H02K 7/116; A45C 5/14

(57) ABSTRACT

Is described an apparatus for the generation of electric current, consisting of an hull wheel (2), of a guide wheel (3), of a current generator body (4) and of a second toothed wheel. The apparatus may be mounted on a suitcase or other vehicles or devices suitable for the transport of goods or people without compromising the ease of production and the available space.

### TECHNICAL FIELD

The present invention concerns an apparatus for generating electric current with the aid of rotating elements.

The systems and tools to generate power by the rolling motion of a wheel are well known.

### BACKGROUND ART

Many of the known systems use small magnetic current generators actuated by suitable gears that allow to reach the angular speeds suitable to obtain specific intensity of electric current.

A first invention regarding such apparatus is described in the patent U.S. Pat. No. 1,210,639 in which the generator is connected to a motorcycle wheel in order to produce electricity for the lights.

This type of system is utilized to provide electric current to small devices that do not require high current intensities, a peculiarity of electronic devices such as cellphone, and others.

To provide electricity, said apparatuses must achieve high angular velocity and this is possible only in the presence of high transmission ratios, also in consideration that in most cases the rotor of generator is very small and it is equipped with knurled or toothed wheel with small diameter.

In the case of cycles and motorcycles, the right transmission ratio is guaranteed by the presence of a very large wheel that belongs to the means of transportation and one very small wheel that belongs to the rotor of generator.

In these cases, even if the means the transportation does not have an high speed, the high transmission ratio ensures an adequate number of revolution to rotor.

About what has been said, it's understandable that such systems are not applicable to small wheels and for low speed, except in the case where it uses a suitable sequence of gears.

This implies that, mounting this kind of systems on a small wheel, as in the case of suitcase, requires to create a very complex system of gear.

To confirm the above, there are the patents US2013/0271063 and US2006/0032687 that both treat the devices in question mounted on a suitcase.

From the study of above patents it's easily understood that the use of small wheels requires complicated system of toothed wheels.

These wheels must be appropriately placed in storage compartments and mechanically connected to the wheel axis.

This implies a total change of the means of transportation structure.

In the case of above patents, the suitcase is considerably transformed to make room for all the components of the invention.

This complicates the production cycle of the suitcase, imposing various supplementary operations to make the final product and also this configurations compromise the capacity of the suitcase

Furthermore, the fact that the mechanical connection between the main wheel and the gears occurs through the axis of rotation of the main wheel, requires the construction of complex systems that avoid to put in communication the inside of the suitcase with the outside just because the main wheel is always external to the suitcase and the transmission axis through the body of the suitcase penetrating the interior to reach the compartment of the gears thereby impairing the seal of the suitcase.

So it will be necessary to implement protective measures but it prejudice the ease of production and cost of the suitcase.

### DISCLOSURE OF INVENTION

The invention, as specified in the claims, solves these drawbacks, because with the invention is achieved a combined system composed of a sequence of toothed wheels mechanically connected to the surface of the wheel and not to the wheel axis.

The invention also provides that all the components, including the wheel of the means of locomotion, are placed in a single box frame in order to achieve the maximum integration between the components and to minimize space requirements.

According to the invention the apparatus is composed of a frame for the wheel, of a guide wheel and a body to generate current, mechanically connected to the wheel guide due to the force exerted by an elastic component.

### BRIEF DESCRIPTION OF DRAWING

The present invention will be better described with the help of drawings which represent only one of the possible embodiments:

FIG. 1 is an isometric view of the apparatus assembled;

FIG. 2 is an exploded isometric view of the apparatus;

FIG. 3 is an isometric view of one of the components of the apparatus and in particular of the hull for the wheel;

FIG. 4 is an axonometric view of the assembled current generator body;

FIG. 5 is an exploded axonometric view of the current generator body;

FIG. 6 is an axonometric view of one of the components of the generator body and in particular of the second toothed wheel;

FIG. 7 is an axonometric view of the apparatus mounted on a suitcase;

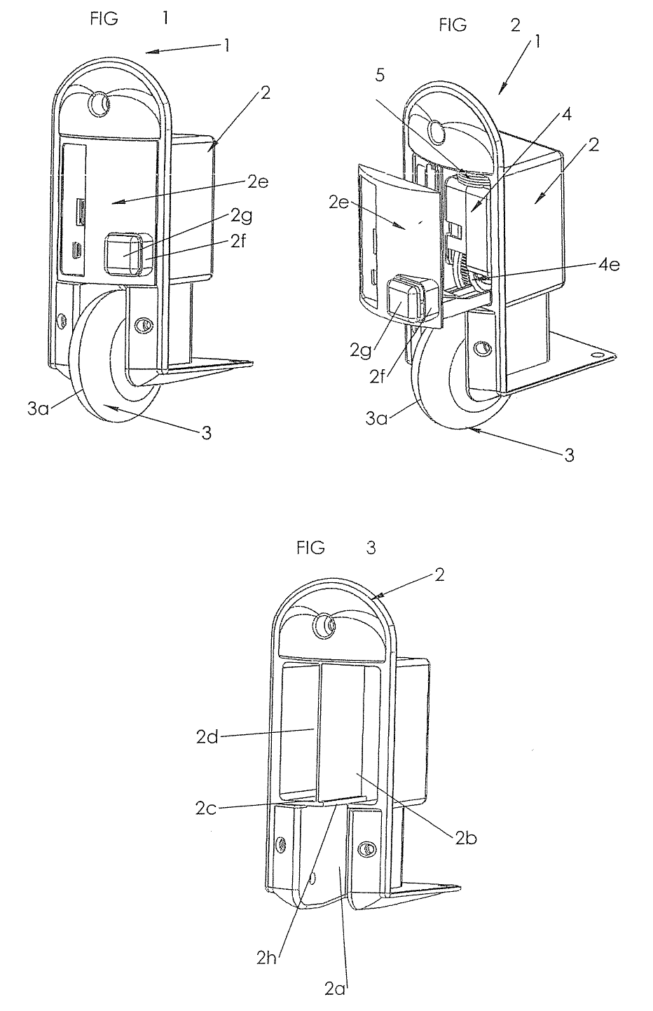

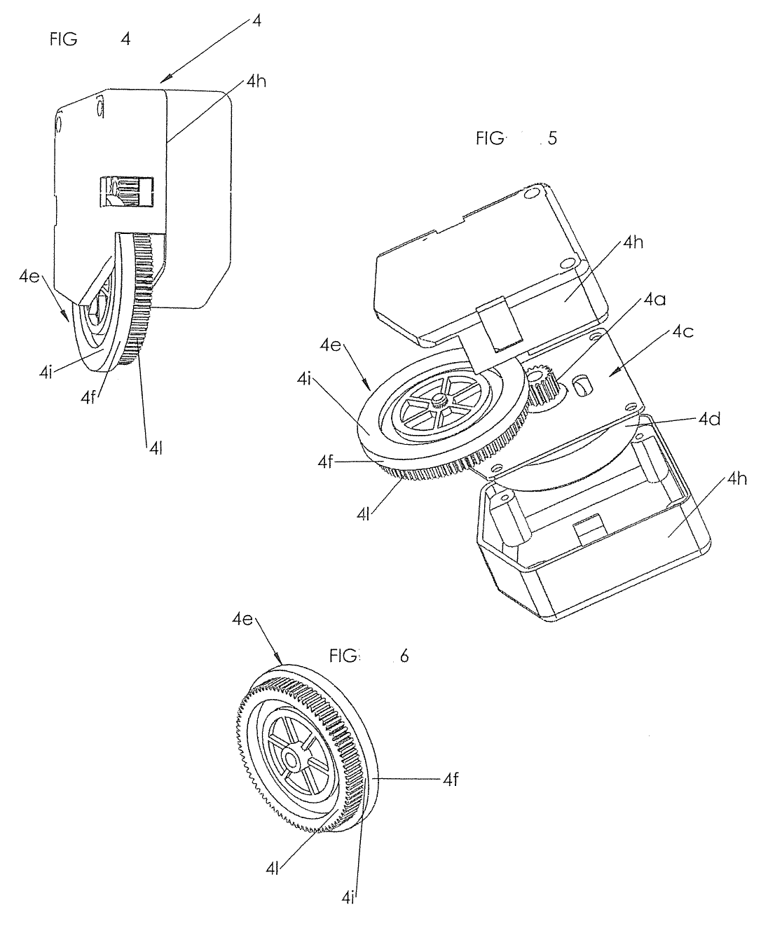

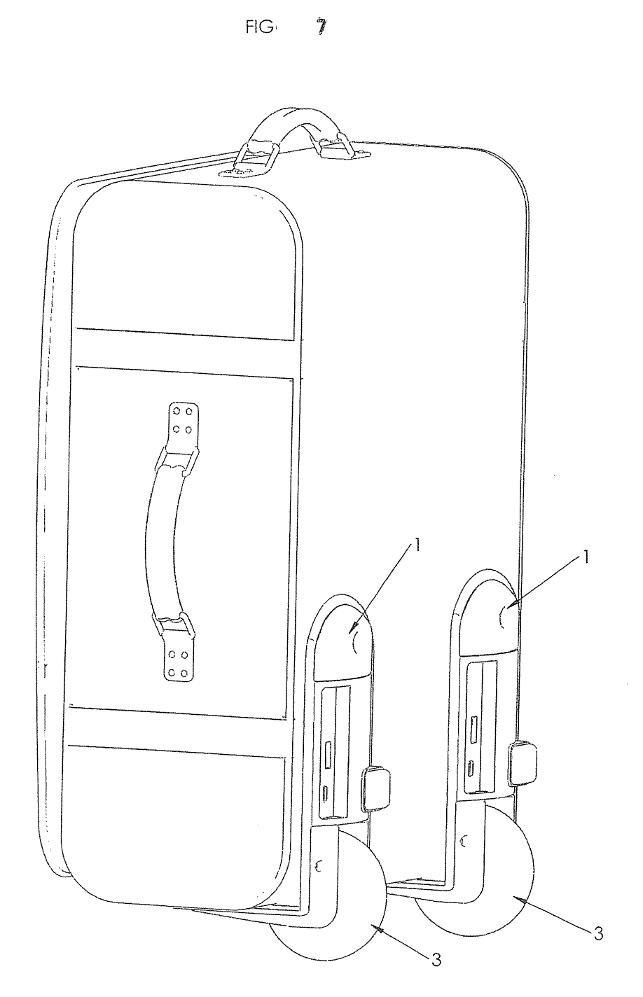

With reference to the drawings an apparatus for producing electric current is indicated by 1. Said apparatus 1 comprises:

hull wheel 2 comprising:
A lower spray guard compartment 2a adapted to contain, secured and free to rotate around its own center, the guide wheel 3;
an upper compartment 2b combined and superimposed on said lower spray guard compartment 2a, by means of the connection wall 2c of the compartments,
a closure cap 2e for the open wall 2d of the top compartment 2a, suitable to ensure stable said current generator body 4 within the upper compartment 2a and said closure cap 2e comprising a housing 2f for a pressure button 2g suitable to lift the current generator body and to release the outer cylindrical surface 4f of the second toothed wheel 4e from contact with the tread surface 3a of the guide wheel 3.

a guide wheel 3,

a current generator body 4 composed of:
a rotating current generator 4c;
a box frame 4h;
a first toothed wheel 4a placed in integral and concentric position with the rotor 4d of the rotating current generator 4c and
a second toothed wheel 4e mechanically connected to the first toothed wheel 4a being said second toothed wheel 4e composed of an cylindrical upper part 4i free from teeth and of a lower cylindrical portion 41 equipped with teeth and said cylindrical portion 4i joined and superimposed on the said cylindrical part 41 being said cylindrical upper part 41 with a larger diameter than the lower cylindrical portion 41
   Said upper compartment 2b is adapted to receive in its interior the current generator body 4, and leaves it free to slide vertically.

Said lower spray guard compartment 2a and said upper compartment 2b are communicating through a slot 2h placed on the connection wall 2c of the two compartments, and said slot 2h is adapted to receive in the middle the accessible portion of the second toothed wheel 4e of the current generator body 4.

Said current generator body 4 is mechanically connected to the guide wheel 3, by means of the thrust that the spring component 10 exerts on the box frame 4h thus allowing the second toothed wheel 4e to be in contact with the tread surface 3a of the guide wheel 3.

In this way the rolling motion of the guide wheel 3 is transmitted to the second gear 4e and thereby to the first toothed wheel 4a.

1. Apparatus (1) for producing electric current composed of a hull wheel (2), of a guide wheel (3), of a current generator body (4) being said body current generator (4) composed of a rotating current generator (4c), of a box frame (4h), of a first toothed wheel (4a) placed in a integral and concentric position with the rotor (4d) of the rotating current generator (4c) and of a second toothed wheel (4e) mechanically connected to the first toothed wheel (4a) and mechanically connected to the guide wheel (3), being said second toothed wheel (4e) held in contact with the tread surface (3a) of the guide wheel (3) by the thrust exerted by an elastic component (10) on the current generator body (4).
CHARACTERIZED BY THE FACT THAT:
said second toothed wheel (4e) is composed of a cylindrical upper part (4i) free from teeth and of a cylindrical lower portion (41) equipped with teeth and said cylindrical upper part (4i) superimposed and joined to said lower cylindrical portion (41) being said cylindrical upper part (4i) with larger diameter than the cylindrical lower portion (41) and
said box frame (4h) of the current generator body (4), suitable to leave uncovered the second toothed wheel (4e) of a portion sufficient to allow free access to the outer cylindrical surface (4f) of the cylindrical upper part (4i) of the second toothed wheel (4e) from outside, and
said hull for the wheel (2) comprising:
a lower spray guard compartment (2a) adapted to contain, secured and free to rotate around its own center, the guide wheel (3);
an upper compartment (2b) joined and superimposed on said lower spray guard compartment (2a), by means of the connection wall (2c) of the compartments, being said upper compartment (2b) adapted to receive in its interior the current generator body (4), said current generator body (4) free to slide vertically within said upper compartment (2b) and positioned so as to the outer cylindrical surface (4f) of the second toothed wheel (4e) is in contact with the tread surface (3a) of the guide wheel (3), being said lower spray guard compartment (2a) and said upper compartment (2b) communicating through a slot (2h), placed on the connection wall (2c) of the compartments, and being said slot (2h) suitable to receive in the middle the accessible portion of the second toothed wheel (4e) of the current generator body (4).
a closure cap (2e) for the open wall (2d) of the upper compartment (2a), suitable to ensure stable said current generator body (4) inside the upper compartment (2a) and said closure cap(2e) comprising at least one housing (2f) for at least a push button (2g) suitable to lift the current generator body and to release the outer cylindrical surface (4f) of the second toothed wheel (4e) from contact with the tread surface (3a) of the guide wheel (3).

2. Apparatus for producing electric current, AS CLAIMED IN CLAIM 1, CHARACTERIZED BY THE FACT THAT said cylindrical upper part (4i)of the second toothed wheel (4e) is made up of soft material as rubber.

3. Apparatus for producing electric current, AS CLAIMED IN CLAIM 1, CHARACTERIZED BY THE FACT THAT the upper compartment (2b) of the hull wheel (2) is composed of at least two compartments and suitable to contain electronic printed circuit boards, batteries and other electronic devices suitable to accumulate and use the electric current generated by the system.

4. Apparatus for producing electric current, AS CLAIMED IN claims 1 and 2, CHARACTERIZED BY THE FACT THAT the closure cap (2e) for the open wall (2d) of the upper compartment (2a) comprising appropriate slots suitable to receive inside the devices suited to the levy of the electric current.

5. Apparatus for producing electric current, AS CLAIMED IN claims 1,2,3, and 4, CHARACTERIZED BY THE FACT THAT the closure cap (2e) for the open wall (2d) of the upper compartment (2a) comprising at least one slot suitable for receiving inside an outlet Universal Serial Bus (USB) type.

6. Apparatus for producing electric current, AS CLAIMED IN claims 1,2,3,4, and 5, CHARACTERIZED BY THE FACT THAT the closure cap (2e) for the open wall (2d) of the upper compartment (2a) is suitable to provide an hermetic seal between said upper compartment (2a) and the external.

7. Apparatus for producing electric current, AS CLAIMED IN claims 1,2,3,4,5, and 6, CHARACTERIZED BY THE FACT THAT the closure cap (2e) for the open wall (2d) of the upper compartment (2a) is suitable to provide an hermetic seal between the compartments that make up the said upper compartment (2a).

8. Apparatus for producing electric current AS CLAIMED IN claims 1,2,3,4,5,6 and 7, CHARACTERIZED BY THE FACT THAT the apparatus (1) is installed on vehicles and devices suitable for the transport of goods and people.

9. Apparatus for producing electric current AS CLAIMED IN claims 1,2,3,4,5,6, and 7, CHARACTERIZED BY THE FACT THAT the apparatus (1) is installed on devices suitable to generate heat by means of electrical resistances.

10. Apparatus for producing electric current AS CLAIMED IN claims 1,2,3,4,5,6, and 7, CHARACTERIZED BY THE FACT THAT the apparatus (1) is installed on devices suitable to generate electric arcs.
